(19) United States
(12) Patent Application Publication
(10) Pub. No.: US 2013/0182807 A1
(43) Pub. Date: Jul. 18, 2013

(54) DEVICE AND METHOD FOR THE PRODUCTION OF RADIOISOTOPES

(71) Applicant: Taylor Ramon Wilson, Texarkana, AR (US)

(72) Inventor: Taylor Ramon Wilson, Texarkana, AR (US)

(21) Appl. No.: 13/710,188

(22) Filed: Dec. 10, 2012

Related U.S. Application Data
(60) Provisional application No. 61/568,343, filed on Dec. 8, 2011.

(51) Int. Cl. G21G 1/02

(52) U.S. Cl. CPC G21G 1/02
USPC 376/108

(57) ABSTRACT

A dense plasma focus (DPF) to produce positron emitters is provided, where a pulsed device has an anode and a cathode arranged in a vacuum chamber, the anode and cathode being subjected to a high voltage. When the vacuum chamber is filled with a reaction gas and a high voltage generated is applied, a plasma sheath is created and a reaction between the electrodes take place to produce plasmoids resulting in an ion beam that interacts with a reactive gas to produce radio-isotopes.

This application claims priority from U.S. Patent Application No. 61/568,343, filed on Dec. 8, 2012, titled “Device and Method for the Production of Radioisotopes,” and which is incorporated herein by reference in its entirety.

### BACKGROUND OF THE INVENTION

1. Field of Invention

Aspects of the present invention relate to methods and systems for the production of radioisotopes. More specifically, aspects of the present invention relate to methods and systems for the production of medical radioisotopes.

2. Description of Related Art

Positron Emission Tomography (PET) imaging in nuclear medicine is one of the most widely used tools in the diagnosis of cancer. For example, fluorodeoxyglucose (FDG), which chemical formula is 2-deoxy-2-(¹⁸F)fluoro-D-glucose, a glucose analog, is tagged with the positron emitting radioactive isotope Fluorine-18 (¹⁸F) substituted for the normal hydroxyl group at the 2′ position in the glucose molecule. Due to the higher metabolism of cancer cells, which results in a higher biological need for glucose, the tumor absorbs the FDG at a higher rate than normal tissue. Once in the cancer cell, ¹⁸F decays, emitting a positron which, after a short travel in human tissue, reacts with an electron to give off gamma rays. As a result, a 3D model of the tumor can be developed by using gamma ray detectors and computer algorithms. Other isotopes that may be used include Nitrogen 13, Carbon 11 and Oxygen 15, and each one of these radioisotopes may have different storing materials.

A typical method of producing isotopes involves bombarding particles, of, e.g., a metal oxide, with an ion beam from a cyclotron accelerator to produce, e.g., ¹⁸F, which has a half-life of approximately 2 hours. Other suitable positron-emitting isotopes include gallium-68 and strontium-82.

While a PET scan is generally a common diagnostic tool in the fight against cancer, the use of a cyclotron to produce radioisotopes such as ¹⁸F presents a significant drawback in that it is a costly technique. Combined with the short shelf life of ¹⁸F of about 109 mn, production and transportation of ¹⁸F via a cyclotron presents serious challenges, currently there is no known method for the production of ¹⁸F other than via the use of a cyclotron or a linear accelerator. Accordingly, there is a need in the art to provide an improved cost-efficient process of producing radioisotopes, particularly isotopes of fluoride, hydrogen and oxygen, without the use of bulky and cumbersome equipment. There is also a need in the art to provide portable isotope production units to produce the radioisotopes in closer proximity to, and/or within, hospitals to reduce transportation time, especially in view of the short shelf life of many radioisotopes.

### SUMMARY OF THE INVENTION

In light of the above described problems and unmet needs, various aspects of the current invention include using a dense plasma focus (DPF) to produce usable quantities of positron emitters, the usable quantities being, for example, in the range of about 1 milli-Curie (mCi) or more. According to various aspects, a DPF that includes a pulsed device has an anode and a cathode arranged in a vacuum chamber, the anode and cathode being subjected to a high voltage from, for example, a large capacitor bank. When the vacuum chamber is filled with an appropriate gas and a high voltage generated by the large capacitor bank is applied, a plasma sheath may be created and a reaction between the electrodes may occur. As a result of the reaction between the electrodes, plasmoids may be created that result in the creation of an ion beam. Within the ion beam, collisions between, for example, Deuterium and Tritium atoms result in nuclear fusion. As such, the ion beam can be used to produce isotopes usable for medical applications.

Aspects of the current invention include an arrangement where the ion beam is created in a first chamber that includes an accelerating gas and is directed to a second chamber that includes a target gas that is distinct from the first chamber, so that a beam created in the accelerating gas interacts with the target gas. Because the target gas is located in a stand-alone chamber, purging of the target gas can be accomplished without disturbing the first chamber that includes the anode. According to other aspects of the current invention, both the accelerating gas and the target gas are included in the same chamber, so that a beam resulting from the high voltage applied to the accelerating gas interacts with the target gas within the same chamber.

Additional advantages and novel features of these aspects of the invention will be set forth in part in the description that follows, and in part will become more apparent to those skilled in the art upon examination of the following or upon learning by practice of the invention.

### BRIEF DESCRIPTION OF THE DRAWINGS

Various exemplary aspects of the systems and methods will be described in detail, with reference to the following figures, wherein:

FIG. 1 is an illustration of an external target isotope production system, according to various aspects of the current invention;

FIG. 2 is an illustration of an internal target isotope production system, according to various aspects of the current invention;

FIGS. 3A-3B are illustrations of a radiation shielding mechanism, according to various aspects of the current invention;

FIG. 4 is an illustration of an anode used in an internal target isotope production system, according to various aspects of the current invention;

FIG. 5 presents an exemplary system diagram of various hardware components and other features, for use in accordance with an aspect of the present invention; and

FIG. 6 is a block diagram of various exemplary system components, in accordance with an aspect of the present invention.

### DETAILED DESCRIPTION OF PREFERRED ASPECTS

These and other features and advantages of this invention are described in, or are apparent from, the following detailed description of various exemplary aspects.

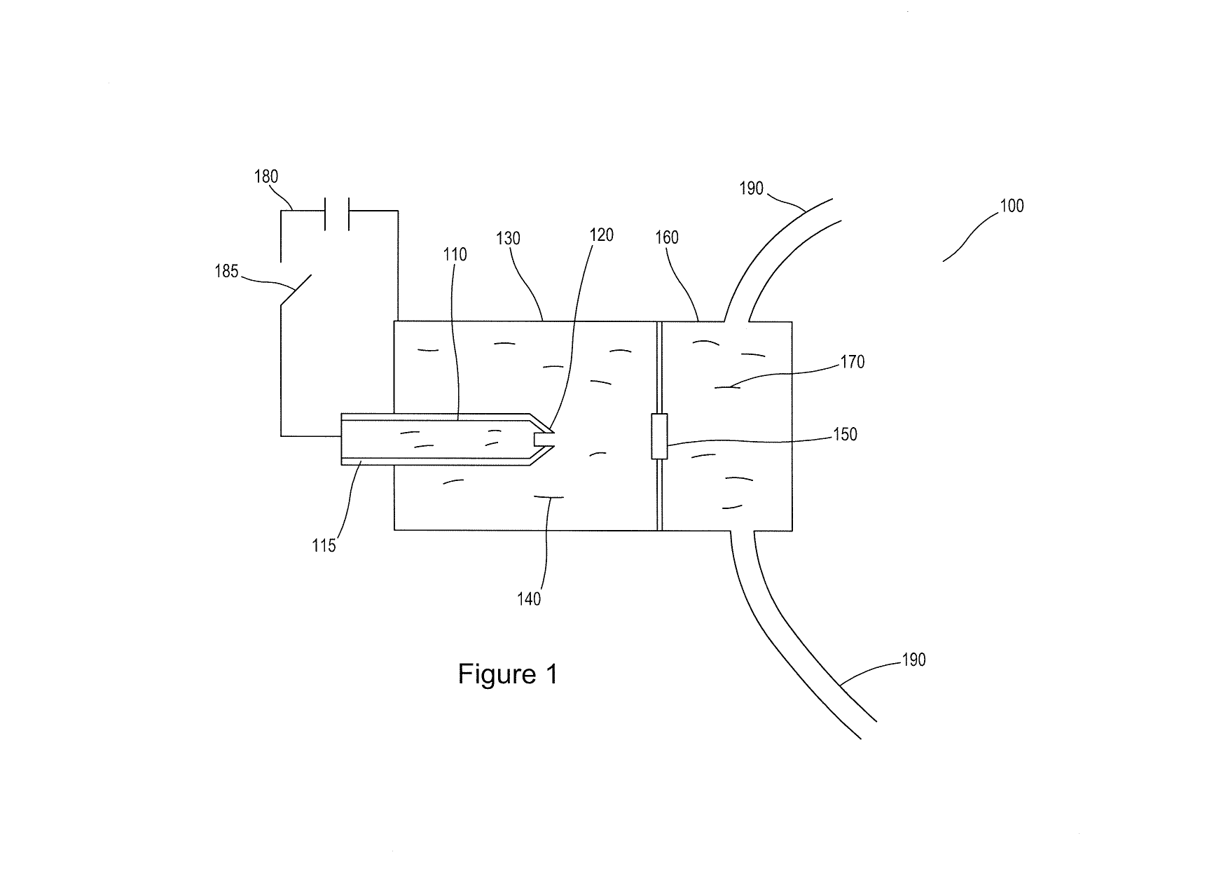

FIG. 1 is an illustration of an isotope production system 100, according to various aspects of the current invention. In FIG. 1, the anode 110 is illustrated as having an elongated shape such as, for example, a cylindrical shape. The anode 110 may be hollow, and may include a divot or recessed portion 120 at one end of the anode 110. According to various aspects, the anode 110 is located inside an accelerating chamber 130, in which an accelerating gas 140 is stored, for example, under pressure. Accordingly, the accelerating gas 140 may be present inside the hollow portion of the anode 110 as well as in the accelerating chamber 130. For example, the pressure in the accelerating chamber 130 may be in the order of 1 to 10 Torrs, and the accelerating chamber 130 may be a stainless steel chamber. On one side of the accelerating chamber 130, a beam window 150 may be provided to connect the accelerating chamber 130, which includes the accelerating gas 140, to a chamber 160 that includes the target gas or target liquid 170, which may include fluorine, oxygen or oxygenated water. According to various aspects, the beam window 150 may consist of a material that has, for example, a low atomic weight, in order to be permeable to the accelerated ions even when the beam window 150 has relatively high thicknesses or when the beam window 150 has a high mechanical resistance. For example, the beam window 150 may be of a material that includes Beryllium. Additionally, the pressure in the chamber 160 may be in the order of 1 to 10 Torrs. According to various aspects, the pressure in the accelerating chamber 130 may be the same or different from the pressure in the chamber 160.

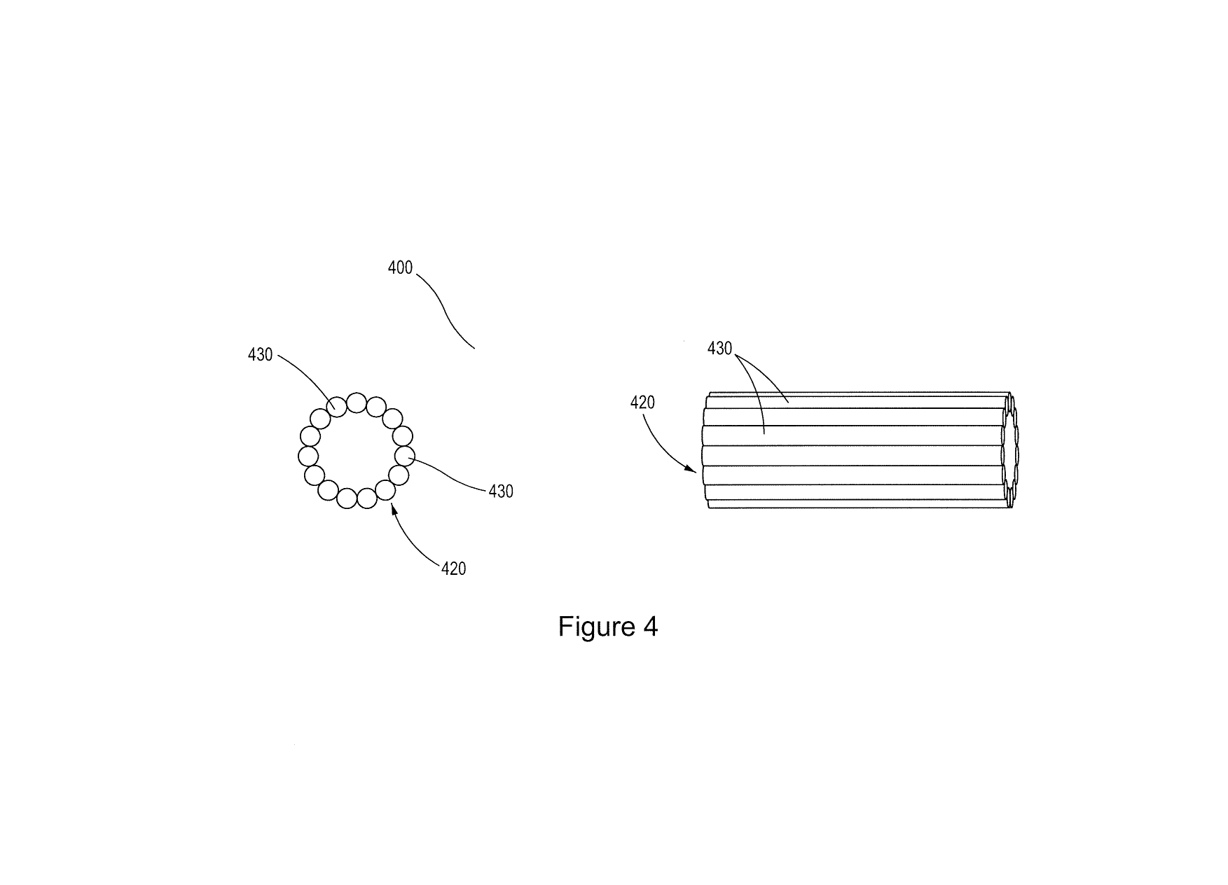

According to various aspects, the anode 110 may consist of a cylinder, or of a plurality of metallic bars organized around a circular base, as illustrated in FIG. 4. In FIG. 4, the base 420 of the anode 400 is composed of a plurality of metallic bars 430. However, according to other aspects of the current invention, the anode may consist of a solid hollow cylinder. With respect to FIG. 1, the anode 110 may also consist of a metal able to withstand high temperatures, and may be connected to a cooling system. For example, the anode 110 may be covered by an insulating layer 115 such as, for example, glass or a glass layer, in order to be insulated electrically and thermally from the accelerating chamber 130. According to various aspects, both the anode 110 and the accelerating chamber 130 are connected to a high voltage source 180 that, when the switch 185 is closed to create an electrical circuit, generates a high voltage that is applied between the anode 110 and the accelerating chamber 130. According to various aspects, the anode 110 may be connected to ground, and the voltage source 180 may be a pulsed device that can subject the anode and the accelerating chamber 130 which, in this case acts as a cathode, to energy from a large capacitor bank.

For example, the energy stored in the capacitor bank may be in the range of 1 kJ to 100 kJ, the high voltage source 180 may generate a voltage of 5 kV to 100 kV, and preferably a voltage of 10 kV to 50 kV, and the resulting accelerating potential may be in the range of 0 MeV to greater than 10 MeV. The pulsing frequency of the high voltage pulsed device 180 may be in the range of about 0.1 Hz to about 10 Hz. In addition, the pulsed device 180 may include a plurality of capacitors, or a bank of capacitors, where the overall inductance of the pulsed device 180 remains low so as to result in a pulse speed or rise time of about 1 microsecond or under about 1 to 2 microseconds.

According to various aspects, in operation, a target gas or liquid 170 may be inserted in the chamber 160 via the conduits 190. Subsequently, when the switch 185 is closed and the voltage source 180 applies a voltage between the anode 110 and the accelerating chamber 130, an electric sheath is created by reaction of the accelerating gas 140 inside the anode 110 with the applied high voltage, and the electric sheath moves in a direction away from the anode 110, which translates into a motion of the sheath towards the divot 120. For example, when the accelerating gas is Helium, an ion beam of He-3 (³He or tralphium), which is a is a light, non-radioactive isotope of Helium with two protons and one neutron, may be created. The accelerating gas may also be, for example, Deuterium. According to various aspects, when the electric sheath reaches the divot 120, the sheath may turn into a plasma via a reaction caused by the high voltage applied to the accelerating gas 140, the plasma creating an endogenic ion beam and moving away from the anode 110. When the anode 110 is oriented in the direction of the beam window 150, the endogenic ion beam moves towards and through the beam window 150 to reach the reaction chamber 160. Accordingly, when the plasma reaches the inside of the reaction chamber 160, the plasma reacts with the target gas 170, and the result of the reaction is the creation of isotopes in the reaction chamber 160. Once the reaction is terminated, according to various aspects, the isotopes or the target gases and/or liquids 170 may be removed from the chamber via the conduits 190, and the target isotopes may be coupled to, for example, a chemical synthesizer to produce one or more radiopharmaceuticals. According to various aspects, various amounts of radioisotopes may be produced, for example in the range of about 1 Curie or more.

According to various aspects, the isotope production system 100 is configured so that the chamber 160 that includes the target gas or liquid 170 is located outside the accelerating chamber 130, and the sheath travels to the chamber 160 to react with the target gas or liquid 170 through the beam window 150. Accordingly, the target gas or liquid 170 can be purged via the conduits 190 without disturbing the accelerating chamber 130 and the accelerating gas 140 that may remain in the accelerating chamber 130.

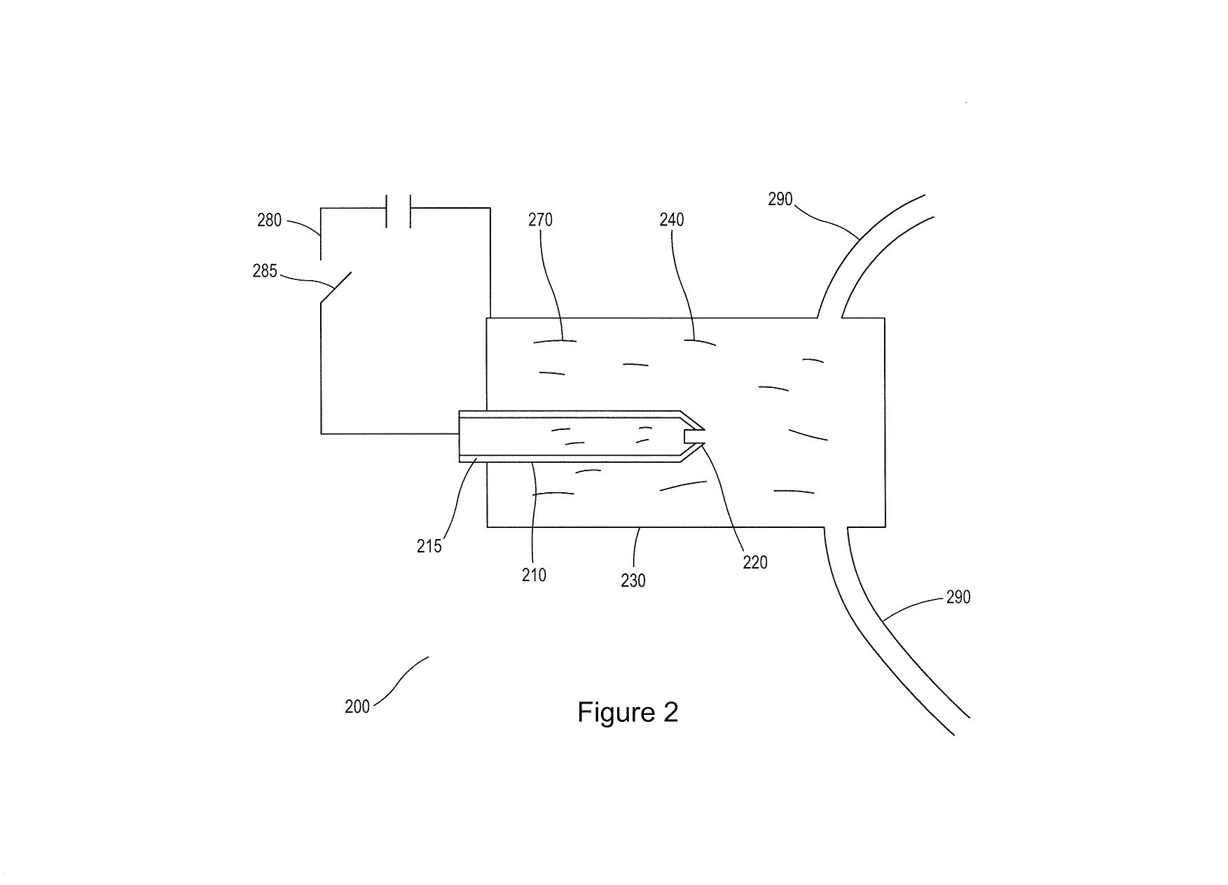

FIG. 2 is an illustration of an isotope production system 200, according to various aspects of the current invention. In FIG. 2, the anode 210 is illustrated as having an elongated shape such as, for example, a cylindrical shape. The anode 210, similar to the anode 110 described above, may be hollow, and may include a divot or recessed portion 220 at one end of the anode 210. According to various aspects, the anode 210 is located inside a single chamber 230 in which both an accelerating gas 240 and a target gas 270 are provided. The accelerating gas 240 and the target gas 270 may be stored in the chamber 230 at atmospheric pressure, and alternatively may be stored under pressure. For example, the pressure in the chamber 230 may be in the order of 1 to 10 Torrs, and the chamber 230 may be a stainless steel chamber.

According to various aspects, the anode 210 may consist of a cylinder, or of a plurality of metallic bars organized around a circular base as illustrated in FIG. 4. The anode 210 may also consist of a metal capable of withstanding high temperatures, and may be connected to a cooling system. For example, the anode 210 may be covered by an insulating layer 215 such as, for example, a glass layer, in order to be insulated electrically and thermally from the chamber 230. According to various aspects, both the anode 210 and the chamber 230 may be connected to a high voltage source 280 that, when the switch 285 is closed to create an electrical circuit, generates a high voltage between the anode 210 and the chamber 230. According to various aspects, the anode 210 may be connected to ground, and the voltage source 280 may be a pulsed device that can subject the anode 210 and the chamber 230 which, in this case, acts as a cathode, to energy from a large capacitor bank. For example, the energy stored in the capacitor bank may be in the range of 1 kJ to 100 kJ, the high voltage source 280 may generate a voltage of 5 kV to 100 kV, and preferably a voltage of 10 kV to 50 kV, and the resulting accelerating potential may be in the range of 0 MeV to greater than 10 MeV. The pulsing frequency of the high voltage pulsed device 280 may be in the range of about 0.1 Hz to about 10 Hz. In addition, the pulsed device 280 may include a plurality of capacitors, or a bank of capacitors, where the overall inductance of the pulsed device 280 remains low so as to result in a pulse speed or rise time of about 1 microsecond or under about 1 to 2 microseconds. According to various aspects, the accelerating gas 240 and the target gases and/or liquids 270 may be added to or removed from the chamber 230 via the conduits 290.

According to various aspects, in operation, the accelerating gas 240 and the target gas or liquid 270 may be inserted in the chamber 230 via the conduits 290, either at the same time, e.g. contemporaneously, or alternatively at different times. Subsequently, when the switch 285 is closed and the voltage source 280 applies a voltage between the anode 210 and the chamber 230, an electric sheath is created inside the anode 210 by a reaction of the accelerating gas 240 inside the anode 210 with the applied the high voltage, and moves away from the anode 210 and towards an opposite end of the chamber 230, which translates into a motion of the sheath towards the divot 220. According to various aspects, when the electric sheath reaches the divot 220, the sheath may turn into a plasma via a reaction at the divot 220, the plasma creating an endogenic ion beam and moving away from the anode 210 towards an opposite end of the chamber 230. Accordingly, when the plasma is created at the divot 220 inside of the chamber 230, the plasma reacts with the target gas or liquid 270, and the result of the reaction is the creation of radioisotopes. Once the reaction is terminated, according to various aspects, the isotopes may be removed from the chamber via the conduits 290, and may be coupled to, for example, a chemical synthesizer to produce one or more radiopharmaceuticals. According to various aspects, various amounts of radioisotopes may be produced, for example in the range of about 1 Curie or more. Because the chamber 230 holds both the accelerating gas 240 and the target gas or liquid 270, both the target gas or liquid 270 and the accelerating gas 240 may be purged via the conduits 290 once the reaction is terminated.

For example, in the case of the production of ¹⁸F, whether using the external target isotope production system illustrated in FIG. 1 or the internal target isotope production system illustrated in FIG. 2, the target gas or liquid 170/270 may be Oxygen-18 (¹⁸O) or ¹⁸O-enriched water which, when colliding with the accelerated ions in the ion beam created by the reaction between the accelerating gas 140/240 and the applied high voltage, causes a (p,n) reaction, which is a nuclear reaction that captures a bombarded proton and releases a neutron, also called a “knockout reaction,” in the ¹⁸O. According to various aspects, the knock-out reaction generates “carrier-free” dissolved ¹⁸F-fluoride (¹⁸F) ions in the target gas or liquid 170/270.

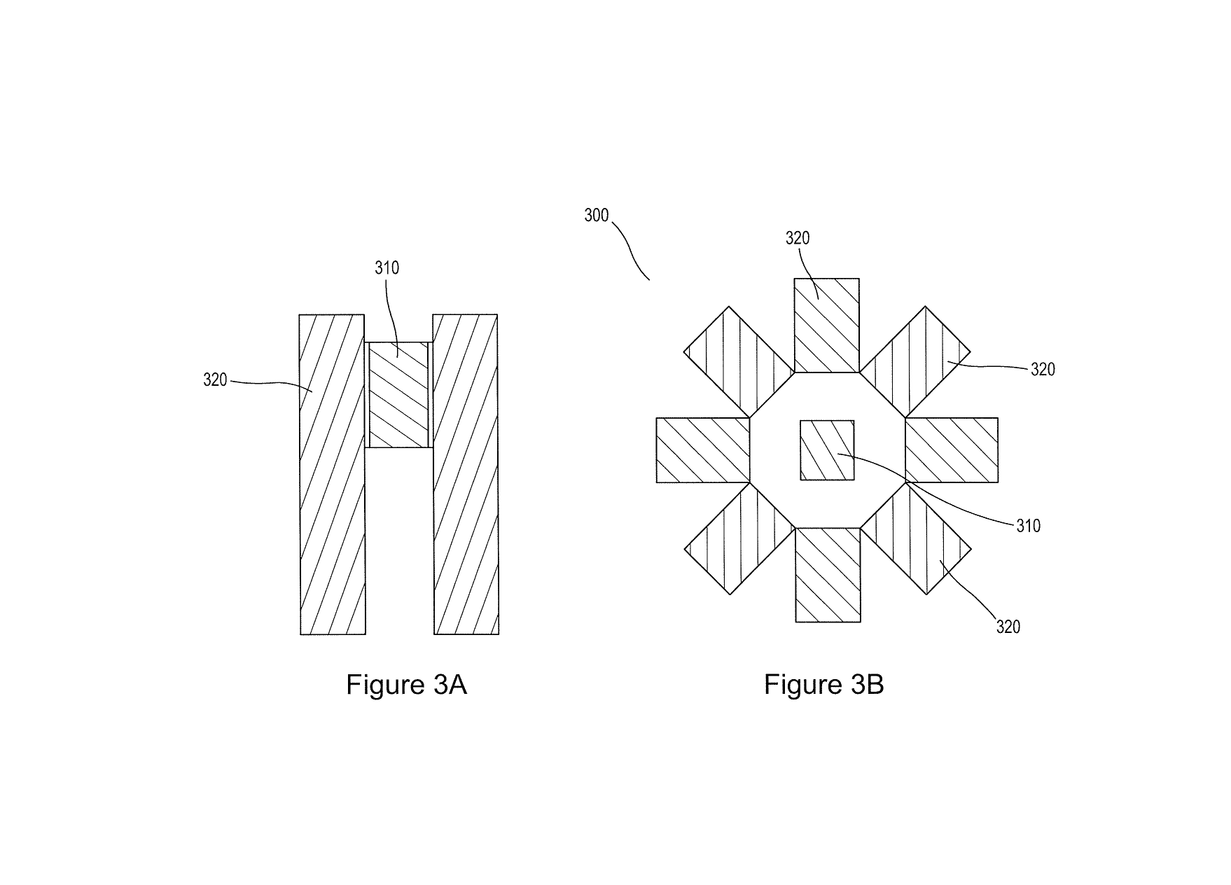

FIGS. 3A-3B are illustrations of a radiation shielding mechanism 300 which can be used to reduce radioactive emanation from a reaction chamber 310, according to various aspects of the current invention. For example, the chamber 310 may be similar to the chambers 230 and 160 described above in which a radioactive reaction takes place, and a number of capacitors 320, such as a bank of capacitors 320, which are typically needed to generate power for the high voltage source such as the high voltage source 180/280 described above, may be physically arranged so as to provide a radioactivity shield to the reaction chamber 310. According to various aspects, integral radiation shielding against stray neutrons or x-ray radiation may be achieved by placing the capacitors 320 integrally, i.e., without leaving any open space between two adjacent capacitors, around the reaction chamber 310, as illustrated in FIGS. 3A and 3B. Due to the inherent shielding characteristics of the capacitors 310 with respect to radioactivity, the arrangement of the bank of capacitors 320 illustrated in FIGS. 3A and 3B may provides adequate radioactivity shielding of the reaction chamber 310. As a result, a portable system 300 may be produced, where the chamber 320 surrounded by the capacitors 310 may be safely transported to various places such as, for example, ports, airports, hospitals, and the like, to be used as needed without the risk of exposing the surroundings to radioactivity. Because the capacitors 320 typically consist of alternating layers of hydrogenous material and metals, the intrinsic material composition of the capacitors 320 may mimic traditional neutron and x-ray shielding. Accordingly, by surrounding the chamber 310 with the capacitors 320, and by filling voids between the capacitors 320, if needed, with additional radioactivity shielding, the isotope production device 300 may be able to be rendered safely portable and used without additional shielding.

According to various aspects, due to the portability of the isotope production device 300, it may be possible to provide a plurality of modular accelerator chambers 310 that may attach to the high voltage capacitors 320 via threads. For example, three different chambers may be provided: i) a chamber that includes an anode-cathode arrangement with a suitable fill gas and a target and a beam window for producing isotopes such as, for example, short lived medical isotopes, and as described above with respect to FIG. 1; ii) a chamber that includes a fill gas of Deuterium (necessitating an energy of 2.45 MeV), Tritium (necessitating an energy of 14.1 MeV), or a combination of Deuterium and Tritium, to produce fusion neutrons to be used, e.g., in neutron interrogation of cargo containers or the detection of explosives through neutron capture and gamma ray emission reaction on stable Nitrogen and a detection of the 10 MeV characteristic gamma ray of the reaction, or the detection of hidden Special Nuclear Material (SNM) through neutron capture and fission and detection of delayed fission neutrons and gamma rays; and iii) a chamber that includes a fill gas of Hydrogen (or protons H+), and a suitable target such as, e.g., Fluorine, to produce mono-energetic gamma rays through a proton capture and gamma ray emission reaction between the target and the accelerated beam of Hydrogen, which provides advantages in security applications because current sources of x-rays and gamma rays for imaging and identification purposes generally use a radioactive source (which presents a security and safety hazard because the radiation cannot be turned off), or produce a broad Bremsstrahlung spectrum instead of a mono-energetic (one wavelength, monochromatic) photon line, the broad spectrum being is less desirable for detection applications than a mono-energetic photon line.

According to various aspects, the three options described above may utilize a similar anode-cathode arrangement, pulse timing and pulsed power supply, and may only differ in the nature of the fill gas, target materials and the existence or absence of an extraction mechanism such as element 190 described above with respect to FIG. 1. In addition, the three anode-cathode arrangement, pulse timing and pulsed power supply may be provided as modules, and switching from one of the three options described above may be achieved by keeping the same anode-cathode arrangement, pulse timing and pulsed power supply and interchanging another module that includes the fill gas, target materials and, possibly, the extraction mechanism. As such, portability and interchangeability may be achieved, which may allow the use of aspects of the current invention in a wide variety of environments and for a variety of applications.

According to various aspects, protecting the environment of the reaction chamber from radioactivity may be accomplished as described above by using the bank of capacitors as radiation shields, and may also be accomplished by promoting a-neutronic reactions or low neutronic nuclear reactions, such as, for example, ¹⁶O(³He,p), where ¹⁶O is bombarded with ³He to produce a proton, or ²⁰Ne(d,α), here ²⁰Ne is bombarded with deuterium to produce α (alpha) radiation, or combinations thereof, in order to generate ¹⁸F. According to various aspects, protecting the environment of the reaction chamber from radioactivity may be accomplished via a combination of the above-described radioactive shielding with the bank of capacitors and the promotion of a-neutronic or low neutronic reactions. As a result, the system according to various aspects may be portable and transported to various locations such as ports, airports, hospitals, and the like,

According to various aspects, the above-described systems and devices may be operated via various hardware and software features including a processor, as described below.

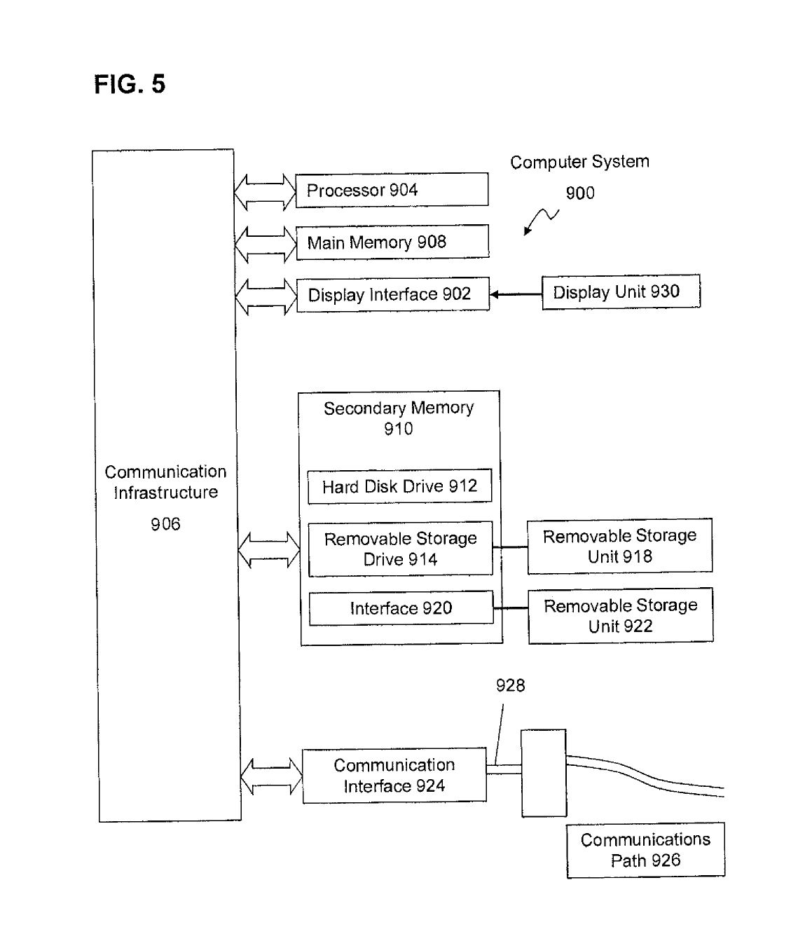

FIG. 5 presents an exemplary system diagram of various hardware components and other features, for use in accordance with an aspect of the present invention. The present invention may be implemented using hardware, software, or a combination thereof and may be implemented in one or more computer systems or other processing systems. In one aspect, the invention is directed toward one or more computer systems capable of carrying out the functionality described herein. An example of such a computer system 900 is shown in FIG. 5.

Computer system 900 includes one or more processors, such as processor 904. The processor 904 is connected to a communication infrastructure 906 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 900 can include a display interface 902 that forwards graphics, text, and other data from the communication infrastructure 906 (or from a frame buffer not shown) for display on a display unit 930. Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well-known manner. Removable storage unit 918, represents a floppy disk, magnetic tape, optical disk, etc., which is read by and written to removable storage drive 914. As will be appreciated, the removable storage unit 918 includes a computer usable storage medium having stored therein computer software and/or data. In alternative aspects, secondary memory 910 may include other similar devices for allowing computer programs or other instructions to be loaded into computer system 900. Such devices may include, for example, a removable storage unit 922 and an interface 920. Examples of such may include a program cartridge and cartridge interface (such as that found in video game devices), a removable memory chip (such as an erasable programmable read only memory (EPROM), or programmable read only memory (PROM)) and associated socket, and other removable storage units 922 and interfaces 920, which allow software and data to be transferred from the removable storage unit 922 to computer system 900.

Computer system 900 may also include a communications interface 924. Communications interface 924 allows software and data to be transferred between computer system 900 and external devices. Examples of communications interface 924 may include a modem, a network interface (such as an Ethernet card), a communications port, a Personal Computer Memory Card International Association (PCMCIA) slot and card, etc. Software and data transferred via communications interface 924 are in the form of signals 928, which may be electronic, electromagnetic, optical or other signals capable of being received by communications interface 924. These signals 928 are provided to communications interface 924 via a communications path (e.g., channel) 926. This path 926 carries signals 928 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 980, a hard disk installed in hard disk drive 970, and signals 928. These computer program products provide software to the computer system 900. The invention is directed to such computer program products.

Computer programs (also referred to as computer control logic) are stored in main memory 908 and/or secondary memory 910. Computer programs may also be received via communications interface 924. Such computer programs, when executed, enable the computer system 900 to perform the features of the present invention, as discussed herein. In particular, the computer programs, when executed, enable the processor 910 to perform the features of the present invention. Accordingly, such computer programs represent controllers of the computer system 900.

In an aspect where the invention is implemented using software, the software may be stored in a computer program product and loaded into computer system 900 using removable storage drive 914, hard drive 912, or communications interface 920. The control logic (software), when executed by the processor 904, causes the processor 904 to perform the functions of the invention as described herein. In another aspect, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another aspect, the invention is implemented using a combination of both hardware and software.

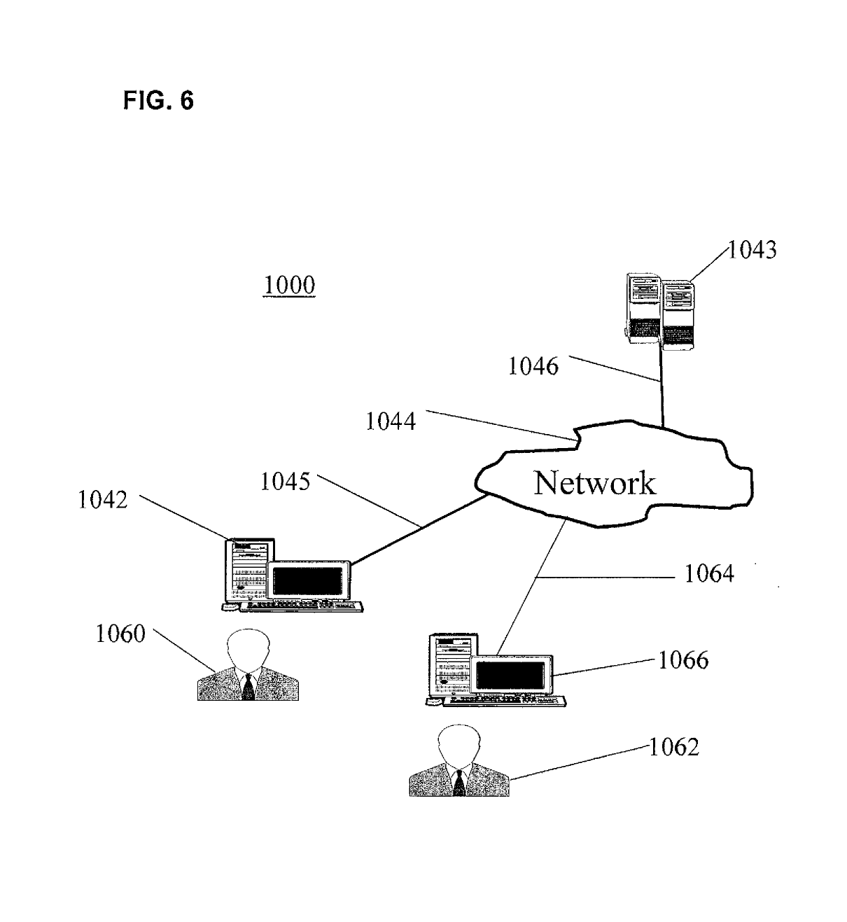

FIG. 6 is a block diagram of various exemplary system components, in accordance with an aspect of the present invention. FIG. 6 shows a communication system 1000 usable in accordance with the present invention. The communication system 1000 includes one or more accessors 1060, 1062 (also referred to interchangeably herein as one or more “users”) and one or more terminals 1042, 1066. In one aspect, data for use in accordance with the present invention is, for example, input and/or accessed by accessors 1060, 1062 via terminals 1042, 1066, such as personal computers (PCs), minicomputers, mainframe computers, microcomputers, telephonic devices, or wireless devices, such as personal digital assistants (“PDAs”) or a hand-held wireless devices coupled to a server 1043, such as a PC, minicomputer, mainframe computer, microcomputer, or other device having a processor and a repository for data and/or connection to a repository for data, via, for example, a network 1044, such as the Internet or an intranet, and couplings 1045, 1046, 1064. The couplings 1045, 1046, 1064 include, for example, wired, wireless, or fiberoptic links. In another aspect, the method and system of the present invention operate in a stand-alone environment, such as on a single terminal.

While this invention has been described in conjunction with the exemplary aspects outlined above, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A device for producing isotopes, the device comprising:
a first chamber including an anode and at least one accelerating gas;
a second chamber including at least one target gas or target liquid; and
a voltage source configured to apply a voltage between the anode and the first chamber; wherein
a reaction of the accelerated gas is produced in the first chamber as a result of the applied voltage, the reaction resulting in a plasma; and
a nuclear reaction between the plasma and the target gas is produced in the second chamber.

2. The device of claim 1, wherein the nuclear reaction results in a production of one or more isotopes.

3. The device of claim 1, wherein
a beam window separates the first chamber and the second chamber; and
the plasma travels from the first chamber to the second chamber through the beam window.

4. The device of claim 3, wherein the beam window comprises Beryllium.

5. The device of claim 1, wherein the second chamber includes conduits to insert or remove components of the nuclear reaction without disturbing the first chamber.

6. The device of claim 1, wherein the anode is an elongated hollow cylinder.

7. The device of claim 6, wherein the anode is covered with a thermal and electrical insulator.

8. The device of claim 7, wherein the thermal and electrical insulator comprises a glass layer.

9. The device of claim 6, wherein
the elongated anode includes a recess at a first end opposite to a second end that is coupled to the voltage source; and
the plasma is created at the first end of the anode.

10. The device of claim 1, wherein the voltage source is configured to apply a voltage of about 5 kV to about 100 kV.

11. The device of claim 10, wherein the voltage source is configured to apply a voltage of about 10 kV to about 50 kV.

12. The device of claim 1, wherein the voltage source comprises a pulsed device with a rise time of about 1 to 2 microseconds.

13. The device of claim 1, wherein
the accelerating gas comprises at least one of Hydrogen, Helium, Deuterium and Tritium; and
the target gas comprises at least one of Fluorine and Oxygen.

14. The device of claim 1, wherein
the accelerating gas comprises at least one of Hydrogen, Helium, Deuterium and Tritium; and
the target liquid comprises at least one of oxygenated water and fluorinated water.

15. The device of claim 1, wherein at least one of the first chamber and the second chamber is kept at a pressure of about 1 to 10 Torrs.

16. The device of claim 1, wherein at least one of the first chamber and the second chamber comprises stainless steel.

17. A device for producing isotopes, the device comprising:
a chamber including an anode, at least one accelerating gas and at least one target gas; and
a voltage source configured to apply a voltage between the anode and the chamber; wherein
a reaction of the accelerated gas is produced in the chamber as a result of the applied voltage, the reaction resulting in a plasma; and
a nuclear reaction between the plasma and the target gas is produced in the chamber.

18. The device of claim 17, wherein the nuclear reaction results in a production of one or more isotopes.

19. The device of claim 17, wherein the anode is an elongated hollow cylinder.

20. The device of claim 19, wherein the anode is covered with a thermal and electrical insulator.

21. The device of claim 19, wherein
the elongated anode includes a recess at a first end opposite to a second end coupled to the voltage source; and
the plasma is created at the first end of the anode.

22. The device of claim 17, wherein the voltage source is configured to apply a voltage of about 5 kV to about 100 kV.

23. The device of claim 22, wherein the voltage source is configured to apply a voltage of about 10 kV to about 50 kV.

24. The device of claim 17, wherein the voltage source comprises a pulsed device with a rise time of about 1 to 2 microseconds.

25. The device of claim 17, wherein
the accelerating gas comprises at least one of Hydrogen, Helium, Deuterium and Tritium; and
the target gas comprises at least one of Fluorine and Oxygen.

26. The device of claim 17, wherein the chamber is kept at a pressure of about 1 to 10 Torrs.

27. The device of claim 17, wherein the chamber comprises stainless steel.

28. The device of claim 1, wherein
the voltage source comprises a bank of capacitors; and
the capacitors are arranged around the first chamber and the second chamber to provide shielding from radiation emanating from the first chamber or the second chamber.

29. The device of claim 17, wherein
the voltage source comprises a bank of capacitors; and
the capacitors are arranged around the chamber to provide shielding from radiation emanating from the chamber.

30. The device of claim 6, wherein the anode comprises a plurality of elongated metallic bars arranged around a circular base.

31. The device of claim 17, wherein the anode comprises a plurality of elongated metallic bars arranged around a circular base.

32. A method of producing isotopes, comprising:
providing an accelerating gas and an anode in a first chamber;
providing a target gas in a second chamber; and
applying a voltage between the anode and the first chamber to create a reaction of the accelerating gas resulting in a plasma beam;
wherein the plasma beam travels to the second chamber and reacts with the target gas to produce a nuclear reaction.

33. The method of claim 32, wherein the nuclear reaction results in a production of one or more isotopes.

34. The method of claim 32, wherein applying the voltage comprises applying a voltage of about 5 kV to about 50 kV.

35. The method of claim 32, wherein
providing the accelerating gas comprises providing at least one of Hydrogen, Helium, Deuterium and Tritium; and
providing the target gas comprises providing at least one of Fluorine and Oxygen.

36. A method of producing isotopes, comprising:
providing an accelerating gas, a target gas and an anode in a chamber; and
applying a voltage between the anode and the chamber to create a reaction of the accelerating gas resulting in a plasma beam;
wherein the plasma beam reacts with the target gas to produce a nuclear reaction.

37. The method of claim 36, wherein
providing the accelerating gas comprises providing at least one of Hydrogen, Helium, Deuterium and Tritium; and
providing the target gas comprises providing at least one of Fluorine and Oxygen.

38. A system for producing isotopes, the system comprising:
means for providing an accelerating gas and an anode in a first chamber;
means for providing a target gas in one of a second chamber and the first chamber; and
means for applying a voltage between the anode and the first chamber to create a reaction of the accelerating gas resulting in a plasma beam;
wherein the plasma beam reacts with the target gas to produce a nuclear reaction.

39. A system for producing isotopes, the system comprising:
a processor;
a user interface functioning via the processor; and
a repository accessible by the processor; wherein
an accelerating gas and an anode are provided in a first chamber;
a target gas is provided in one of a second chamber and the first chamber;
a voltage is applied between the anode and the first chamber to create a reaction of the accelerating gas resulting in a plasma beam; and
the plasma beam reacts with the target gas to produce a nuclear reaction.

39. A computer program product comprising a non-transitory computer usable medium having control logic stored therein for causing a computer to control isotope production, the control logic comprising:
computer readable program code means for providing an accelerating gas and an anode in a first chamber;
computer readable program code means for providing a target gas in one of a second chamber and the first chamber; and
computer readable program code means for applying a voltage between the anode and the first chamber to create a reaction of the accelerating gas resulting in a plasma beam;
wherein the plasma beam reacts with the target gas to produce a nuclear reaction.
